(19) United States
(12) Patent Application Publication
(10) Pub. No.: US 2011/0303201 A1
(43) Pub. Date: Dec. 15, 2011

(54) Spark intensifier system

(76) Inventor: Harry A. Romano, Naples, FL (US)

(21) Appl. No.: 12/802,656

(22) Filed: Jun. 14, 2010

(51) Int. Cl. F02P 3/02; F02P 3/05

(52) U.S. Cl. 123/620; 123/623

(57) ABSTRACT

Disclosed is a spark plug arc intensifier system that influences the arc of the spark plug at any given performance of the gasoline engine. The intensifier system consists of a microcomputer that applies an additional signal to the lead-in wire coming from the transformer coil of the engine to influence the intensity of arc of the spark plug. This system results in a complete burning of the air/fuel mixture that is prevalent at the time of combustion. This system then results in a cleaner environment, less fuel consumption and a more powerful performance of the engine.

### BACKGROUND OF THE INVENTION

As the title of the invention suggest this inventive concept is directed to a system that intensifies the spark of a spark plug while a vehicle is in operation. Investigations have found that 15% to 40% of the gasoline that is consumed by an internal combustion engine is not burned during combustion and is expelled right through the exhaust system. To maintain the “greening” of the environment a catalytic converter was required which will consume the unburnt gasoline while the vehicle is in motion with the engine running. An ignition system exists in all gasoline, natural gas and propane engines.

This phenomenon of unburnt fuel is being recognized throughout the industry and many modifications have been tried. Especially, in the development of spark plugs. It has been recognized that intensifying the spark of a spark plug has beneficial results at certain times while the engine is operating.

U.S. Pat. No. 4,983,882 is called the “Ignition Amplifier Device”. While it may be of some benefit in the operation of a gasoline engine, it is not capable of changing the intensity of the spark which is an object of the invention.

Another spark plug development is known as the PULSTAR™ which discloses a spark plug that incorporates a capacitor in the line of the spark current. This again may be beneficial in certain engine operations but this known sparkplug still cannot change the intensity of the spark while a vehicle engine is in operation.

U.S. Pat. No. 5,201,302 discloses a voltage regulator tube for an ignition system of an internal combustion engine. An electric circuit of a known ignition system with a voltage regulator tube by which a high voltage can be stably supplied to a spark plug without being influenced by a grounding member disposed adjacent to the voltage regulator tube.

U.S. Pat. No. 5,936,332 and its Continuation-In-Part U.S. Pat. No. 6,060,822 discloses a spark plug which eliminates misfire of an internal combustion engine. Its main construction consists of a spark plug having at its ignition end a dome electrode having at least one semispherical surface connected to a second end of the spark plug body. While the improved performance with regard to improving the spark in the disclosed spark plug is not being questioned, however as in all other known spark plugs, the intensity of the spark cannot be changed.

### BRIEF DESCRIPTION OF THE INVENTION

The Sparkamplifier™ is a stand-alone electronic device that piggy-backs onto the existing ignition system. It makes the ignition spark 1000 times more intense and most importantly, it is adjustable so that it can be set to just the right amount of spark intensity according to any sensed and given operation of the engine. A brief explanation discloses that once the inventive system is installed on the engine the following occurs:

As soon as the engine ignition causes a spark, the Sparkamplifier™ senses it and then amplifies it over 1000 times or for whatever it is being adjusted to. Utilizing this method has many benefits. This action causes all of the fuel to burn in each of the cylinders. The effect and benefit one gets is that all of the fuel will now be burned in the engine which is not being sent out of the tailpipe as pollution and greenhouse gases. During this process, the engine gains horse power and the extra horse power can be utilized to give better fuel mileage. The Sparkamplifier™ has no ill effects on the vehicle's timing and one actually feels the difference at the gas pedal of one's vehicle.

### BRIEF DESCRIPTION OF THE DRAWINGS

FIG. 1 illustrates the spark amplifier's high voltage mixer and sense Block;

FIG. 2 shows the ground of the system brain block.

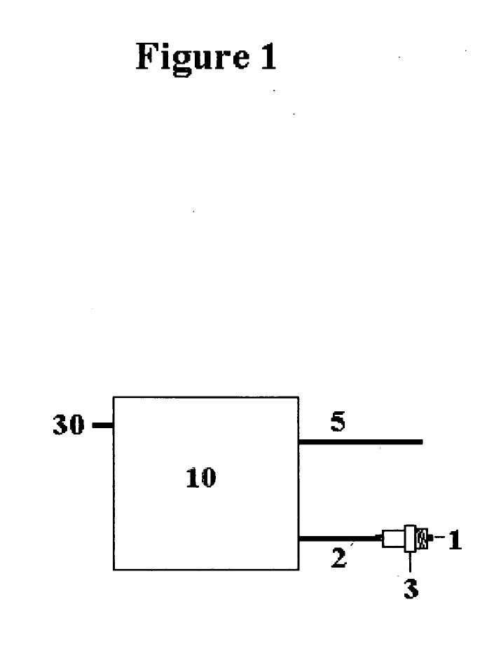

FIG. 1 shows the part of the circuit which is used to mix the added current to the engine's original ignition spark. It senses the spark and then adds as much current necessary to get the spark to amplify. This block in FIG. 1 can be achieved by several different circuits and configurations but they will all do the same thing as described above. This block can also sense positive and negative sparks. Different configurations of this block will be made to accommodate various types of ignition systems. As stated above, the general use of the block stays the same.

The reference character 1 is the output electrode of the spark plug and this is where the spark will be used to ignite the fuel. No. 1 may also be referred to as the spark gap of the spark plug.

The numeral 2 illustrates a special resistor wire that limit's the flow of the current to the spark gap of the spark plug, while 3 is the spark plug ground. 5 is the original spark plug wire coming from the distributor or coil pack of the plug device of the original ignition system. The reference character 10 illustrates the block of the high voltage mixer and sense circuit. It is designed in series with the engine's original spark cable 5.

At 30 is shown where the signal from the brain unit is inserted. This signal is created by the brain unit and will combine with the original spark that will be displayed or present at the spark plug gap 1.

The functional description of FIG. 1 is as follows:

A signal is applied to 30 when the original or basic engine's ignition sends a spark a spark to the spark plug gap 1 while the number 10 block senses it and mixes it with the number 30 signal to thereby form a larger or more powerful spark that is delivered through number 2 to the spark plug in the engine's cylinder. This more powerful spark accomplishes several things. It creates a larger flame front in the cylinder to thereby burns most of the fuel that a smaller or ordinary smaller spark (the original spark) could not do. It will give the original sparks in all of the cylinders more power to arc through more dense air/fuel mixture to thereby improve starts and acceleration. The larger or more powerful spark will lead to air/fuel mixtures, that provide an engine, with better fuel economy. The more powerful spark will also lead to the introduction of new fuels such as water. Testing of the spark amplifier on a vehicle has been proven to increase the vehicle power output. This additional power can be used to create fuel for the motor to burn. Theses fuels can include hydrogen and oxygen.

Since the larger or more intense spark burns the additional fuel that is in the cylinder, the engine will be efficient and will not put out or expel the un-burnt fuel into the environment. The benefit of this additional fuel burning in the cylinder will give the engine an increase in horse power and a cleaner burn. Normally, the exhaust would go out of the cylinder to the catalytic converter and would be burnt up therein. This is a waste of fuel that provides no return but is lost in heat. The inventive spark amplifier reclaims this fuel and uses it in the engine. The exhaust system of the engine will now have less hydrocarbon output which equates to a cleaner environment.

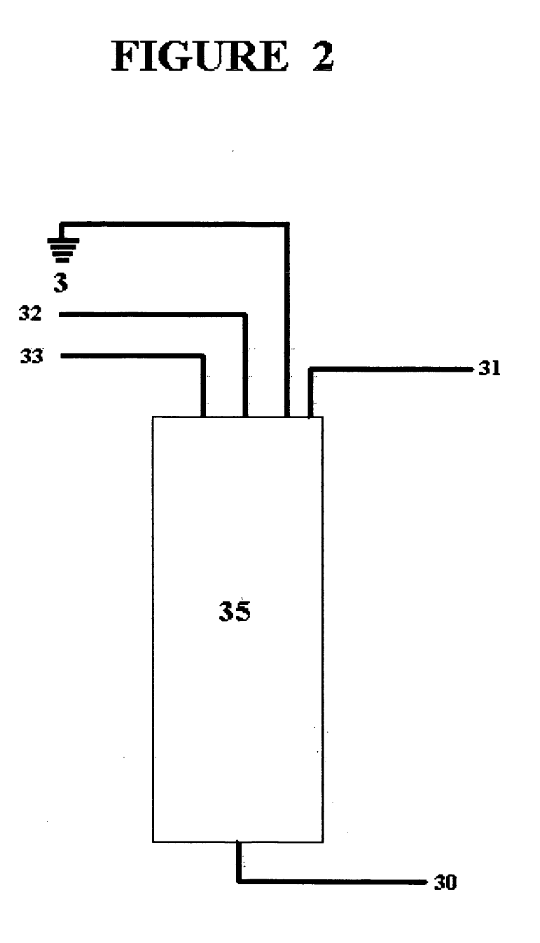

Turning now to FIG. 2 there is ground shown at 3 at the system brain block. Numeral 30 is where the signal comes out of the block and is forwarded to the block of FIG. 1 as the number 30 input. At 31 is shown the brain's computer interface that communicates with the engine's computer or an external computer. Various control signals, communications, operating information and settings will be communicated through this port 31. This port 31 can also be wireless. At 32 is where the input power from the battery is placed and forwarded to the block which powers the brain unit. 33 is the signal input from the engine's main power switch and is used to turn on the block 35. The block 35 constitutes the brains of the spark amplifier. This unit creates all the signals and monitors all functions pertaining to the spark amplifier. This unit can be arranged in several different configurations and circuits but will always perform the same duties. This unit contains a microcomputer, proprietary firmware, sensors, power supplies, soft start circuits and a wired or wireless communications port.

The functional description of the unit 35 is as follows: A battery voltage must be applied to ports 32 and the ground to port 3. A voltage must also be applied to port 33. After those connections are made, the unit 35 will turn on and supply the necessary signal via port 30 to the block 10 in FIG. 1. At this time the engine will have all signals that are required to amplify the spark plug's arc resulting in an improved engine performance and a fully consumed air/fuel mixture. This, as mentioned above, saves fuel consumption and improves the clean air requirements of the environment.

No spark plug amplifier systems are known in the prior art.

What we claim is:

1. A spark amplifier system in an internal combustion engine having a fuel system, a distributor and a spark transformer coil that has a lead wire leading to any of the spark plugs on said engine, said system having a micro-computer that creates a signal that is sent to said lead wire as an addition to a normal signal to thereby influence the intensity of the spark plug arc.

2. The spark amplifier of claim 1 including a voltage mixer and a sensor.

3. The spark amplifier of claim 2, wherein said voltage mixer and said sensor are connected in series with said lead wire.
